(19) United States
(12) Patent Application Publication
(10) Pub. No.: US 2013/0231999 A1
(43) Pub. Date: Sep. 5, 2013

(54) METHOD AND APPARATUS FOR PERSONALIZED MARKETING

(71) Applicants: ROBERT EMRICH, Santa Maria, CA (US); GOLDBERG SAMUEL, Santa Monica, CA (US)

(72) Inventors: ROBERT EMRICH, Santa Maria, CA (US); GOLDBERG SAMUEL, Santa Monica, CA (US)

(21) Appl. No.: 13/598,547

(22) Filed: Aug. 29, 2012

Related U.S. Application Data
(60) Provisional application No. 61/575,888, filed on Aug. 30, 2011.

(51) Int. Cl. G06Q 30/02

(52) U.S. Cl. CPC G06Q 30/0271
USPC 705/14.43; 705/14.67

(57) ABSTRACT

The system provides personalized marketing combined with the satisfaction of gamified applications and playing games, which provides a unique offer presentation entertainment solution with the computer implemented capacity to personalize offers. The system includes a learning module that collects data and behavioral information from each user and customizes advertising, offers, and even application utility/play for the user. Over time, the system provides interaction with the user that provides consumer opportunities that are more likely to be accepted by the user.

This patent application claims priority to U.S. Provisional Patent Application Ser. No. 61/575, 888 filed on Aug. 30, 2011 which is incorporated by reference herein in its entirety.

### BACKGROUND

There are a number of ways to generate income on the internet. One model is to provide content to attract a viewer to a web site and to present advertising or present offers to the visitor. Income can be generated by the number of visitors that view a particular ad. In addition, internet ads and offers are clickable in that a user can click on the ad or offer to reach a site provided by the advertiser where product purchase can be completed, or at least additional information can be provided about the product or products being advertised. An internet user who “clicks through” on an ad link is more valuable than a user who merely views a web page that includes advertising. Therefore, internet advertisers are interested in ways to encourage a user to click on an ad or more actively engage with internet advertising.

Currently, some advertising and offer presentation solutions attempt to provide consumers with offers, such as discounts, specials, temporary sales, and the like, but these solutions fall short of the needs of the consumer because they do not provide on-going engagement. Other offer presentation systems have high customer acquisition costs and fail to achieve optimal user engagement.

One current method of increasing the engagement of a user with a website is to provide compelling entertainment or compelling content. The theory is that the longer a user is engaged on a site, the greater the chance that the user can react to the offer or advertising presented. In other circumstances, the user is required to watch an ad prior to, or as a short interruption of, viewing of content. One method of user engagement is to provide games for the user to play. These solutions have disadvantages because there is no requirement that the player view the advertisements presented on the site.

Another disadvantage of current advertising systems is the lack of personalization for each user. There are attempts to provide ads of interest to a visitor to a web site based on predicted demographics. In addition, a system may have some user history that can be useful in customizing ad and offer presentation to the user, but still existing systems to not provide a truly personalized user experience.

### SUMMARY

The system provides personalized marketing combined with the user satisfaction of gamified applications and playing games, which provides a unique offer presentation entertainment solution with the computer implemented capacity to personalize offers. The system includes a learning module that collects data and behavioural information from each user and customizes advertising, offers, and even application utility/play for the user. Over time, the system provides interaction with the user that provides consumer opportunities that are more likely to be accepted by the user.

The system provides a plurality of applications and games that can be played by a user of the system. Depending on the embodiment, a user may or may not be required to make a purchase to utilize the system. The system presents players with the opportunity to win a tangible benefit regardless of their application/game outcome. In one embodiment, the system incorporates “achievements” that present the user with rewards based on gameplay and certain actions. Some of the achievements can be improved offers (e.g. 35% off instead of 30% off, longer redemption time limits, multiple users of coupons, and the like).

Transparency:

From the merchant's perspective the system's performance based marketing is the clearest form of marketing transparency currently available. Merchants are eager to work with a company that can deliver qualified buyers from another source to their online or in-person store. The system does not require merchants to pay until a transaction is consummated. This is true performance based advertising, which is generally regarded to be the most desirable type of advertising for merchants.

The system allows merchants to distribute offers with a very high degree of variability in all attributes of the offer. That, combined with a sense of “winning” an offer, presents offers in such a way that a merchant could choose to have a spectrum of offers ranging from negative margin to revenue generating and could control the distribution of those offers temporally, demographically, or individually. The system has online and offline utility, for this system may offers that could be used in physical stores.

The system's technology presents merchants a way to create multiple tiers of offers (e.g. $1 or $100 off) to multiple demographics of users through the exciting delivery system of applications or playing games. Through analysis of user behaviour, the system allows merchants to identify individuals with a high likelihood of becoming customers, and also to create offers that are likely to be accepted by users.

The system now will be described more fully hereinafter with reference to the accompanying drawings, which are intended to be read in conjunction with both this summary, the detailed description and any preferred and/or particular embodiments specifically discussed or otherwise disclosed. This system may, however, be embodied in many different forms and should not be construed as limited to the embodiments set forth herein; rather, these embodiments are provided by way of illustration only and so that this disclosure will be thorough, complete and will fully convey the full scope of the system to those skilled in the art.

### BRIEF DESCRIPTION OF THE DRAWINGS

FIG. 1 illustrates an embodiment of a structure of the system.

FIG. 2 illustrates one embodiment of interaction with the system.

FIG. 3 is a flow diagram illustrating the initial log-in to the system in one embodiment.

FIG. 4 is a flow diagram illustrating operation of the system at the user interface in one embodiment.

FIG. 5 is a flow diagram illustrating application or game play in one embodiment of the system.

FIG. 6 is a flow diagram illustrating the presentation of an offer in one embodiment of the system.

FIG. 7 is a flow diagram illustrating the operation of the Offer Wheel in one embodiment of the system.

FIG. 8 is a flow diagram illustrating an embodiment of user preference collection.

FIG. 9 is a flow diagram illustrating product placement in one embodiment of the system.

FIG. 10 is a flow diagram illustrating an offer in an embodiment of the system.

FIG. 11 is a flow diagram illustrating an embodiment of ad generation in the system.

FIG. 12 is a flow diagram of an embodiment of offer creation in the system.

FIG. 13 is a flow diagram illustrating an embodiment of personalization in the system.

FIG. 14 is an example computer environment.

### DETAILED DESCRIPTION OF THE SYSTEM

The system provides a computerized process for personalizing offers in association with digital/online/mobile applications or games. The system may be implemented on a website, mobile app, video game console or networked consoles, or social networking site. In the examples below, some are described in conjunction with the offer of a game. It should be understood that even though a game is mentioned, the system can provide applications (e.g. “apps” and the like) entertainment, or other environments without departing from the scope and spirit of the system. In one embodiment, the system presents an application, game or other form of entertainment to a user. During the course of user's interaction with the system, user is presented with an offer which the user may accept or decline.

If user accepts the offer, then user completes the offer on the same platform or is transported to a purchasing interface with specific instructions on how to consummate the earned offer. In some embodiments, the redemption form a user completes for the advertiser is integrated into mobile, browser or other technology so that the form may appear in native format. The form may utilize an auto-fill function for personal (or other information). So instead of displaying a click-through ad, the user is shown a redemption form native to the applicable platform (mobile, browser, console, etc).

The system incorporates many styles of games, which may include, but are not limited to: Tabletop games, Board games, Card games, Dice games, Casino-style games, Miniature games, Pencil-and-paper games, Tile-based games, Role-playing games, Chess game Video games, Arcade games, Computer games, Console games, Handheld games, Mobile games, Online games, Flash games Alternate reality games, Educational games, trivia, Card Games Children's games, Creative games, Lawn games, Letter games Play-by-mail games, Play-by-post games, Locative games, Mathematical games Parlor games, Party games Conversation games, Daring games, Guessing games, Singing games, Paper and pencil games, Playground games, Pub games Drinking games Puzzles, Quizzes, Redemption games, Role-playing games Skill games, Street games, Travel games, Wargames, and Word games

The system may provide a number of features to the user including:

1. Virtual Currency—earned by users by performing elements that may be displayed or connected to the user interface.

2. Offer Wheel—displays offers that emanate from an offer generator. The offer generator is a personalization engine that matches an offer (from a portfolio of available offers) to the user's preference(s). In the absence of known user preferences, then the offer generator will select the “highest quality” offer to present to the user (based on business criteria and the performance history of offer in the system). The Offer Wheel may be in the form of a slot machine, a prize wheel, or other embodiment.

FIG. 7 is a flow diagram illustrating the operation of the Offer Wheel in one embodiment of the system. It should be noted that the Offer Wheel may not appear in every game or embodiment of the system. At step 701 the system identifies the current user. At step 702, the system retrieves personalization information of the user. At step 703 the system applies the personalization information to the offer generator. At step 704 the offer generator identifies a plurality of offers that represent the best match for the user's personalization data. It should be noted that the matches may also be influenced by other metrics, such as time of day, day of week, time of year, recent user activity, and the like. In one embodiment, the system identifies at least a certain number of offers to place on the offer wheel (e.g. 5, 10, or 20). The system has the flexibility to automatically format the offer wheel so that whatever the number of offers may be, the offer wheel appears fully populated with no blank spaces.

At step 705 the system applies a filter to the selected offers to determine if any offers should be excluded from the offer wheel. This may be due to an offer being explicitly rejected, or it may be that an offer has just been presented to the same user and repetition is discouraged. There may also be rules, conditions, or metrics defined by the offer provider (e.g. merchant, advertiser, publisher, and the like) that would result in it being excluded at this point. At step 706 the system populates the offer wheel with the best ranked offers and presents the offer wheel to the user at step 707.

At step 708 the user may then activate the offer wheel.

3. Presented offers—In one embodiment, the system provides offers to users during the course of their interaction with the system.

4. Offer Store—a virtual store where users may exchange virtual currency for offers. The Offer Store embodiments include a variety of methods for redemption. Offers available to players in said Offer Store may be redeemed in exchange for: virtual currency, points, completed levels in a game, special events in a game (for example, acquiring an in-game magic potion or unlocking an in-game special bonus or achievement), or another method. The Offer Store makes offers available to the player in a presentation format (this format allows players to select an offer): an overlay, a popup, a scroll menu, a link stating “You Won a Free Offer!” (or similar text), or other method. The Offer Store may also provide categories of offers (for example: women's apparel, sporting goods, electronics, etc) from which a user may select available offers. The Offer Store may also show a compare and contrast list of items for sale from a particular merchant at a price before the offer is implemented, and then showing the price of the item after the offer is implemented (for example, a bicycle for $100 is the current price at Store X. The $100 bicycle at Store X is then compared by the system to a discounted price of $80 for the Store X bicycle when a user implements the relevant Store X offer). The process of a player selecting an offer would then include the user engaging in one of the redemption methods (above) in combination with an offer selection method (above) that results in the player receiving an offer.

5. User preference collection—users enter information that indicates a user's preferences for deals, goods, or services. This may appear as a checklist, scroll menu, popup, empty text box asking for key words, or some other embodiment.

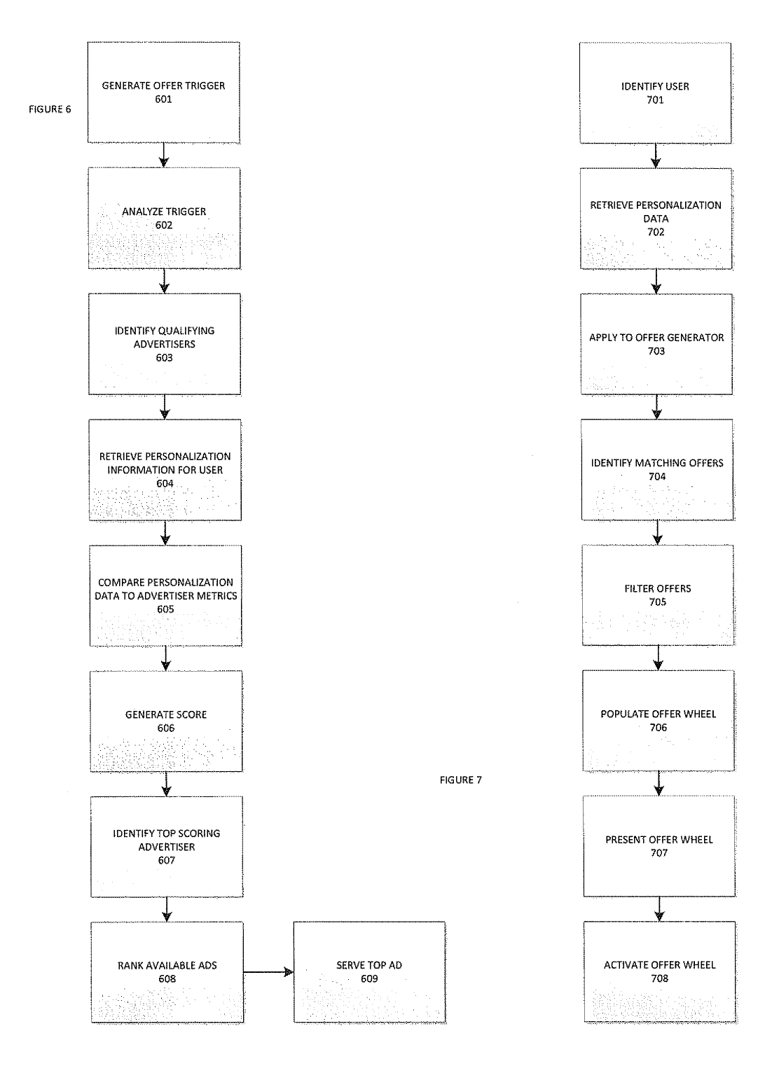

FIG. 8 illustrates an example of user preference collection in an embodiment of the system. At step 801 the system presents the user with specific queries to solicit demographic information or consumer preference information. This may be at account creation time, on a regular calendar basis, or periodically as desired. If the user has previously provided responses to the queries, the step may just be a confirmation that the user data is still up to date and current. At step 802 the system checks for any personal accounts of the user that have been associated with the system, such as social network accounts, game system accounts, and the like. If so, the system scrapes personalization and preference data from the associated accounts at step 803.

At step 804 the system pulls historical data from the system associated with the user. This historical data can include data on apps/games played, number of log-ins, time spent in the system, offers clicked, offers accepted, offers purchased, applications downloaded and other historical data that represents the interaction of the user with the system.

At step 805 the system applies a preference generation algorithm to the collected preference data to generate a preference profile for the user. This preference profile can be used in other parts of the system to match the user with offers to optimize the user experience, to maximize the chance of offer acceptance, and to provide returns to advertisers and merchant partners of the system. Completing this preference profile may also facilitate faster generation of offers and personalization in the system because less system resources will be used in the future if this step is done first. One example of a preference profile may include a list of items, services, goods, and the like in which the user has expressed an interest either explicitly or implicitly. The table below is one embodiment of categories in the present system.

Apparel

Arts & Crafts

Automotive

Books

Clearance

Dating

Department Stores

Education

Electronics & Computers

Entertainment

Event Tickets

Financial

Food

Games

Gift Certificates

Gifts & Flowers

Health

Holiday

Home

Jewelry

Maternity

Musical Instruments

Office

Outdoors

Pets

Sports

Teens

Travel

Weddings

Wine & Spirits

6. User information collection—users enter demographic information, which may sync with their social networking information, or provide the system with other information.

7. Timer—a timer keeps track of how long each user is logged on to the system. The timer also indicates how long a user is spending on any part of the system including individual apps/games.

8. Scoreboard—The Scoreboard may be a public or private metric kept for users to see who has the highest scores on particular apps/games. Metrics are also be kept for offer accepts, the amount of savings users have accumulated, etc. Scoreboards may appear in a variety of embodiments using various temporal (for example, daily, weekly, monthly, lifetime or other variable timeframe) or metric scoring. Scoreboards also appear in individual games and may appear in the form of a filling thermometer or other visual device to indicate when a player is close to earning an offer.

9. Friend invitation—users invite friends to join the system (the company's website or platform). The system also allows users to post badges, and/or pictures of themselves with the system's emblem, on other websites.

10. Friend play with other users—the system allows friends to set up applications, games, or other forms of entertainment to play with their designated “friends.” To do so, the system in one embodiment enables an “invite” system that locks out other, non-invited players from joining the game.

11. Product placement in applications, games, or another form of entertainment—the system will establish product placement in applications, games, or another form of entertainment. Product placement will occur by installing brand and/or product specific source code into the applications, games, or another form of entertainment that displays the brand/product in the applications, games, or another form of entertainment. From the player's perspective, this brand/product will appear to be part of the applications, games, or another form of entertainment.

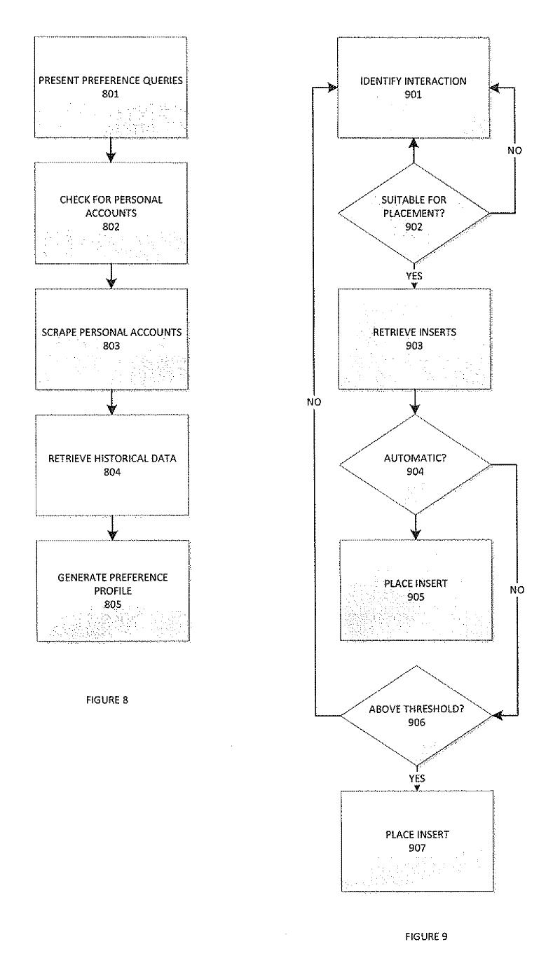

12. Product placement in applications, games, or another form of entertainment+purchasing component−products placed in games (for example, a first person shooter game), where user may pause applications, games, or another form of entertainment (or select an item through some other means), select item, review item, and purchase item from a vendor associated with the product. For example, if a man wearing a suit walked through a game screen, then the player has the ability to select the suit (by clicking on it using a “purchase select” or equivalent function), see the specifications of the prospective suit purchase (colors, sizes, price, etc), and then complete the purchase. The same may be applied to television programs or mobile apps with respect to the ability to identify an unmarked product on the screen (for example, a man wearing a suit) and use this identification/selection process to enable the ability to purchase the item(s). FIG. 9 is a flow diagram illustrating the product placement operation in an embodiment of the system. At step 901 the system identifies the interaction selected by the user. This may be a game, an application or some other interaction. At decision block 902 the system determines if the game is suitable for a product placement insertion. If not, the system returns to step 901.

If so, the system proceeds to step 903 and identifies the inserts that may be used with the game. There may some games (or other interactions) where an advertiser has paid in advance for product placement. In other instances, the advertiser may only wish to pay for the insertion when the user's personalization data is above a certain matching threshold. At decision block 904 the system determines if the insert is an automatic insert (e.g. regardless of personalization data). If so, the system adds the insert at step 905. If not, the system proceeds to decision block 906 to determine if the user personalization is above the insertion threshold. If so, the system inserts the placement at step 907. If not, the system returns to step 901.

13. Affiliate Cookie—tracking cookies will be used to enhance user preferences as well as continue the consummation/purchase of offers. Tracking cookies may stay active indefinitely or have a preset or yet-to-be-determined expiration.

14. Advertising for third parties—third parties advertising may be incorporated into the system and include various forms (banners, pop-ups, etc).

15. Advertising for the system—users that promote the system through advertising will be rewarded with offers or virtual currency. In addition to earning offers or virtual currency through play, users may also receive virtual currency or unique offers through promoting the system. Promotional activities include posting on social networking sites, inviting other users via email to join the system, etc.

17. Real World Events—real world events, like election outcomes, sporting events, or weather will be available for users to “guess” and win virtual currency or immediate offers, The Real World Events may also be personalized based on the database determining the types of events a user has interest in following. In one embodiment, the user may receive a personalized offer incorporating information about a real world event. For example, the user is at a major league baseball game where the using is playing an app that allows the user to guess if the next batter will get a hit. Based on the user's performance, the system may generate a personalized offer generated from the user's history, profile, performance at the real world event, performance while watching the real world event, and/or other business criteria. The offers could be physically delivered (for example, an usher could bring the user a hot dog at the game), emailed, delivered to mobile device, or otherwise delivered to a user electronically.

18. Location based virtual currency bonus—the system enables users to earn more virtual currency if they visit system selected locations and log-on with user's mobile device (for example, visiting their local department store and logging in to the system with user's mobile phone).

19. Deal-of-the-day system: The described system may also be used for deal-of-the-day offers like those found on Groupon or Living Social. The typical deal-of-the-deal enables a customer to purchase a gift certificate for a higher value than the amount paid. (For example, receiving a $50 gift certificate to Acme, Inc. in exchange for $25 payment). The system incorporates a unique aspect of presenting gift certificates.

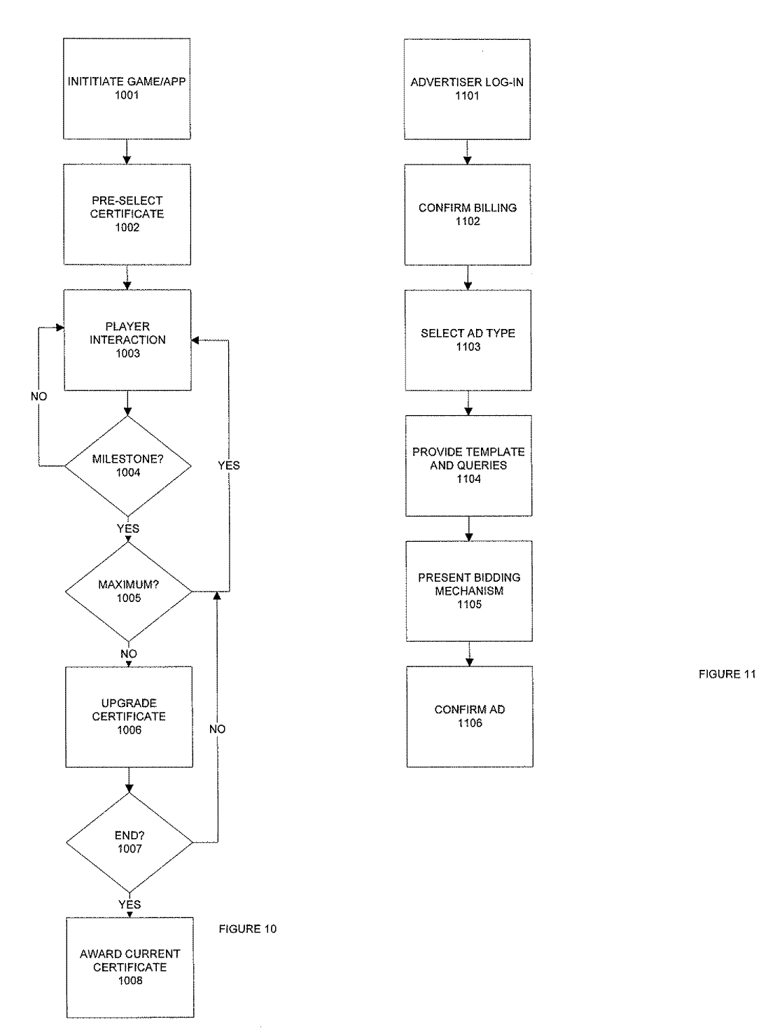

The process is as follows as described in FIG. 10:

At step 1001, player initiates applications, games or another form of entertainment. At step 1002, a player may pre-select a gift certificate as the potential offer for play. A player starts with the ability to buy a gift certificate for face value (for example, the gift certificate has a face value of $50, so the player may purchase it at the commencement of the game for $50). At step 1003, the player begins interaction with the system (i.e. plays a game, interacts with an app or entertainment, and the like).

Through achievements/milestones completed during app/game play or interaction, the player receives a higher value of gift certificate in exchange for the same $50 payment (for example, a player passes a level in an app/game, so now the player's $50 purchase buys a gift certificate with a value of $55). Alternatively, the player starts with a $50 gift certificate face value, and through completing achievements/milestones during app/game play, the price the player has to pay for the same $50 value gift certificate is lowered (for example, a player passes a level in an app/game, and now may buy a gift certificate worth $50 for only $45).

At step 1004 the system determines if the player has reached a milestone or achievement. If not, the system returns to step 1003 and play continues. If so, the system proceeds to step 1005 to determine if the maximum upgrade to the certificate has already been achieved. If so, the system returns to step 1003 and play continues. If not, the system proceeds to step 1006 and the certificate is upgraded.

At decision block 1007 it is determined if the interaction is ended. If not, the system returns to step 1003. If so, the system awards the current level of the certificate at step 1008. As noted above, this may be an increased value of a certificate for the original price, a lower price for the same value of the certificate, or some combination thereof.

In one embodiment, a cap is placed on the amount of additional value the player may receive, so as to “max out” the potential reward for each gift certificate (for example, in the embodiment where a player earns more value for the same price paid, then a player may not receive more than $100 in gift certificate value for a $50 purchase. Alternatively, for the embodiment where a player pays less for the same value of gift certificate, then a player may not receive a $50 gift certificate value for less than $25). In another embodiment, the deal-of-the-day user does not know the exact merchant for the gift certificate or offer; rather, the system generates a personalized offer for the user.

20. For Advertisers:

a. Advertiser interface—a platform for the system and advertisers (third party merchants) to exchange information. The advertiser interface allows advertisers to login to the platform to view the platform's unique analytics. These analytics include:

i. specific customer demographics/metrics for players that have interacted with the advertiser that has logged on (for example, Macy's can see information about customers of the platform that have used the platform to go to Macy's).

ii. customer demographics/metrics that are accumulated for the entire universe of players on the platform

iii. recommended offers that the platform generates through algorithms that analyze player spending habits and suggests to advertisers the optimal offer structure/metrics in order to maximize revenues (for example, algorithms detect if the players spend 30% more if the offer is in the form of a set percentage off of the purchase prices (for example, “20% of Macy's merchandise”). The algorithm then determines the optimal percentage off to maximize revenue (based on the historic activity of player's spending or the player's demographic categories), and then provides recommendations to advertisers on what specific offers are likely to maximize the specific advertiser's revenues.

b. Internal affiliate network—third party merchants may go directly to the system's advertiser interface and provide offers to present to users.

The system will also Present Advertisers with Demographic Data from their industry or associated industries/advertisers that have associative relationships with advertiser's products/offerings. The system can use geo-location mechanisms in mobile devices to permit location based advertising or offers (e.g. using users' latitude and longitude to present offers when the user is within a certain distance from the advertiser's locations). With personalization, the system can also track and monitor how many of an advertiser's customers that have received offers (with said offer comprising of when XYZ criteria) are met (online criteria) actually visit the advertiser's physical store. Therefore, the advertiser will obtain information on the types of offers to be presented online/mobile that will drive traffic to the advertiser's physical store.

Self-Serve Ads for Offers Using a Formula to Determine Ad and Ad Price

In this embodiment, the system provides an interface that allows an advertiser to create an offer using templates provided by the system. This precludes the need to have an advertising company prepare the offer, or even to have in-house staff prepare the offer. The system allows the advertiser to create an offer, match the offer to a set of metrics to identify a particular player or type of player (or even to a specific player in one embodiment), and to choose an offer delivery method. The system provides a mechanism and system for determining the Ad and the Ad Price.

FIG. 11 is a flow diagram illustrating the operation of the self-serve ad system in one embodiment. At step 1101 the advertiser logs into the system. At step 1102, the system confirms the billing arrangement for the advertiser. The arrangement may be billed later, pay immediately, pay set fee, performance based billing, pay ala-carte depending on the ad generated, or the like.

At step 1103 the advertiser selects the ad or offer type that the advertiser would like to present to the user, as well as the demographics of the targeted customer. Different types of ads or offers are defined in categories as described below. The advertiser will also identify the categories of interest, provide a desire monthly budget, daily budget cap, gender of the target (it may be both or either), one or more age ranges, and geographical information (e.g. country, state/province, metro area/city/town).

After selecting the Ad or Offer type, the system at step 1104 presents the advertiser with templates for that ad type and queries to assist in generating an ad. The queries solicit information that is then automatically added to the ad or offer when presented in the system.

After presenting the advertiser with templates for ad type and ad generation, the system at step 1105 presents a bidding mechanism enabling advertisers to make bids on the types of ads they would like to place in the system. At step 1105 the system also allows advertisers to bid for premium placement that would augment the advertiser's offers in the queue to receive priority placement amongst the users the advertiser wishes to reach.

The ad generation process may be freeform, with or without image and writing. The system may allow the advertiser to provide a link/URL/FB page/mobile site/etc. The system may present a process for offer types where the price may adjust based on type of offer; (example free offer=10 cents; free+conditional offer=15 cents; etc.—see below under “Offer Auto-Creation for Advertisers”) or the price may be adjusted based on click through rates.

At step 1106, the advertiser confirms the ad and it is now available for use in the system. In one embodiment, the system may ask the advertiser for a desired result (e.g. click-through rate, offer acceptance, and the like) and the system may identify the optimal ad type to achieve the desired result.

Promotion Creation Mechanism for Advertisers

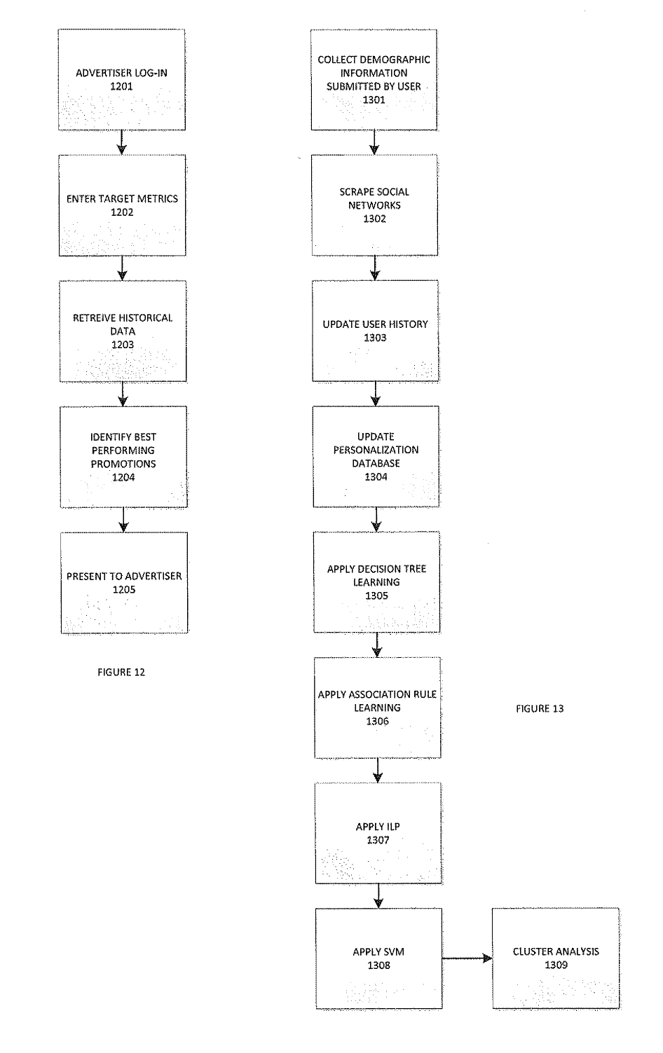

The system also includes a service for advertisers that helps to define an optimized promotion for the advertiser. In some cases, an advertiser knows the demographic that the advertiser wants to reach, but may not know the best promotion with which to reach that demographic. Because the system has extensive historical and demographic information on prior promotions, the system can identify the optimal promotion for a particular demographic. FIG. 12 illustrates an example of an embodiment of this process.

This process takes advantage of the system's statistical database. The system classifies promotions into one or more of several types and categories. Each promotion type is associated with historical data of when the promotion type has been offered or presented and the results of each presentation. This allows the creation of meaningful data about the performance of the promotion type and when it works and doesn't work, as well as for which demographic indicators the promotion has been most successful.

### Examples of promotion types include, but are not limited to, the following

Dollar amount off for whole store ($10 off)

Dollar amount off for specific category or good ($10 off kitchen; $10 off tables)

Dollar amount off with time conditions ($10 off until August 31) (may apply to all free categories—see above)

Dollar amount off with Conditions ($10 free with a purchase of $20 or more; $10 free for new customers)

% off everything (20% off at Gap)

% off with conditions (20% off with a purchase of $20 or more)

% off categories (20% off shoes at The Limited)

% off with time conditions (20% off until August 31)

Free (free t-shirt)

Free with conditions (free T-shirt with purchase)

Free category (free item from the $1.99 section)

Free with time limit (Free T-shirt until August 31)

Buy one get X amount free

Sweepstakes

Contest

Cost-per-action survey (Fill out this survey and get a free T-shirt)

Cost-per-action information (provide us with your contact information and get a free T-shirt)

Special Price ($2.99 for Special Toy)

Special price with: conditions/time limitations/category specific

At step 1201 the advertiser logs into the system. At step 1202, the advertiser enters target demographic information, type of products they offer, and desired performance metrics (e.g. click-through rate, offers redeemed, and the like). At step 1203 the system retrieves historical information associated with the target metrics identified by the advertiser in step 1202. At step 1204 the system identifies the best performing promotions and suggests the best performing promotion based on promotions targeting similar demographics as well as products that performed well (click, redemption, etc). At step 1205 the best performing promotions are presented to the advertiser along with performance metrics so that the advertiser can select the one that best suits the advertiser's needs.

Offer Auto-Creation for Advertisers

The auto-creation of an offer is a mechanism to encourage advertisers to create better offers so that users have a better experience and are more likely to redeem advertiser's offers. In one embodiment of the system, the price charged to advertisers is in some manner dependent on the cost of the offer to the user. For example, when an advertiser provides an offer that is free to the user, the price to the advertiser will be lower than if the offer has a cost to the user. Thus, the cost increases if the anticipated redemption rate is lower—this results in a balance in cost-to-redemption because something that is free with conditions may be redeemed only 15% of the time whereas something that is totally free may be redeemed 45% of the time. Therefore, the system incentivizes advertisers to create offers that are more likely to be redeemed. The system uses historical data (elements that the system has collected) as well as category and industry data (elements from the system or from external sources) to determine a subjective/objective balance of redemption likelihood and cost to advertisers.

Automatic Verification for Advertisers

Automatic verification to determine that links for ads remains active. When a link/destination is added by an advertiser, the system captures all elements of code and creative. In some cases, the ad may have a designated end date. In other instances, the ad may be open ended. The system may periodically pings/scrapes the destination page to determine if the page is active. The system may also cache the HTML and other code on the page, and then periodically cheek to see if the code was changed. The system may do this to preserve the fidelity of matching offers presented within the system to the redemption page. If it is not, the system sends an alert so that users of the system are not presented with defunct offers or deals. In other embodiments, the system may automatically pause the offer or classify it as inactive and even remove the offer from the system or the live bucket of offers being presented to users . . .

Personalization

The present system incorporates a Personalization Mechanism/Methodology/Process, which stores, databases, and organizes user information. Algorithms/programs utilize this information in order to present users offers they are more likely to accept.

An embodiment of the personalization of the system is illustrated in the flow diagram of FIG. 13. Demographic information will be requested/harvested at step 1301, such as (but not limited to): name, gender, age, occupation, location, interests, hometown, relationship status, education level, names of schools attended, country of origin, credit history, income, employment history, IP Address, Neilson DMA, MAC address, cookies or other indicators of previous website visits, user behavior obtained through tracking of mouse, keyboard or other human/machine interface point, or the like.

At step 1302, the system accesses information from social networks or third party aggregation services by scraping data from those systems or through contractual arrangement with those systems. Such systems can include, in addition to social networks, other personal information gathering devices such as computerized smart glasses like Google glasses, computerized smart vehicle like Google car smart silverware, smart-phones, and any other device that can provide information about the user. At step 1303, the system builds a history of the user with the system itself (e.g. machine learning from user interaction with system including history of binary acceptance/denial of offers, clicks, games played, offers purchased, temporal metrics, risk preference, style of play, and the like), Because users are regularly presented with offers, the system accumulates a large amount of user choice information data. The applications/gaming element is instrumental in gathering user choice information, for applications and games engage users to remain engaged with the system. The element of “winning” or “earning” presented offers also provides the system with a higher rate of user interaction because users feel compelled to take advantage of offers that are won (or perceived by the user to be earned or won). The information obtained through these processes is stored on servers on a database at step 1304.
At step 1305 the system applies decision tree learning using a decision tree as a predictive model which maps observations about an item to conclusions about the item's target value.

At step 1306 the system applies association rule learning to the collected data. (Association rule learning is a method for discovering interesting relations between variables in large databases). These associations are stored in the user's personalization database and form part of the personalization profile of the user.
Inductive logic programming (ILP) at step 1307 is an approach to rule learning using logic programming as a uniform representation for examples, background knowledge, and hypotheses. Given an encoding of the known background knowledge and a set of examples represented as a logical database of facts, the ILP system will derive a hypothesized logic program which entails all the positive and none of the negative examples.
Support vector machines (SVMs) are a set of related supervised learning methods used at step 1308 for classification and regression. Given a set of training examples, each marked as belonging to one of two categories, the SVM training algorithm builds a model that predicts whether a new example falls into one category or the other.
Cluster analysis or clustering at step 1309 is the assignment of a set of observations into subsets (called clusters) so that observations in the same cluster are similar in some sense. Clustering is a method of unsupervised learning, and a common technique for statistical data analysis.

Associations made between offers in different categories (for instance “travel” and “electronics”) is developed by the system to determine cross-category personalization. For example, the system may determine a positive correlation between Airlines offers (or a specific airline, like Delta) and laptop computers (or a specific laptop like a 13″ monitor Dell Computer). In one embodiment, a user that clicks on an airlines offer will then be identified as a likely candidate to accept a laptop computer offer (this association then triggers the system to load laptop computer offers or the like into a user's queue of offers). These associations may be developed based on user behavior, user demographics, advertiser metrics/desired demographics, or other business criteria.

The system can obtain personalization data from any source. For example, the system can obtain information from game systems (e.g. Xbox, PlayStation, Wii, Kinect, and the like) or other forms of information sources (photo analysis technology, tv viewship analysis technology, computerized smart glasses like Google glasses, computerized smart vehicles like google car, smart silverware, smart phones, mobile devices, and the like) and use the information to further refine the personalization of the user.

Derive Risk Preference from Game-Play

The system can utilize user behaviour to determine the user's risk-preference and identify the level/type of offer as well as the frequency of offer presentation that is optimized for that user. For example, if player A is an aggressive (risky) player and player B is a meek player, the system will note that in player profiles. The level of riskiness may be determined by a player's willingness to choose high-risk items in the game. If an offer is presented and player A clicks on it and player B does not, the system may determine that this offer is preferred by risky players. If another player C plays the game, and if player C is classified as a meek player, the system will present an offer—with a strong positive correlation to meek players (like player B)—to player C and may not present offers preferred by risky players (like player A). As data points and history accumulate for specific players, apps/games, and the system as a whole, then this risk preference derivation becomes more accurate.

For casino style games, a user's risk profile is assessed, and the user is then presented with free chips, coupons or other elements to incentive the user to play a game where the casino has better odds of winning. For instance if there is a very aggressive player playing blackjack (a game with more balanced odds) our system might offer a free token to play a more risky game.

Like risk preference, the system may also derive information based on the user's length of play, propensity to share offers on social networks or via email, speed of play, and the like. The offers could be physically delivered, emailed, delivered to mobile device, or otherwise delivered to a user electronically.

TV Viewership

Utilizing television monitoring/tracking technology, or another method to determine the shows and advertisements viewed by a user, the system can personalize offers based on shows/commercials that a user viewed, did not “fast-forward through,” did not “mute,” or other business criteria. This information is also retained to update the user's personalization information. In one embodiment, the user is tracked, and the system provides contextual offers. The offers could be physically delivered, emailed, delivered to mobile device, or otherwise delivered to a user electronically. The offers could also be delivered to a store's database/system, so upon checkout, the user will automatically get discount from the offer.

Photo Analysis

In one embodiment, the user may receive an offer based on analysis of photos. Photos may be of the user, of the user's activities, friends, favorite places, and the like. Information from user's photos is utilized by the system to determine associations as well as facilitate offer personalization. For example, a hair dye offer could be presented to someone with neon colored hair in their photo. Another example is presenting an offer for New York because the user has photos of the Empire State Building on their social network page. The offers could be physically delivered, emailed, delivered to mobile device, or otherwise delivered to a user electronically.

Computerized Smart Vehicle (Driverless Car)

In one embodiment, the user may win an offer while in a computerized smart vehicle (driverless vehicle, for example Google car), and then the vehicle may drive the user to a location to redeem the offer. Alternatively, the system presents offers based on the destination or route a user enters into the computerized smart vehicle. In another embodiment, a vehicle interactive system such as OnStar (or related) type services provide information that we can then also customize offers. For example a user may be driving and passengers are watching a video or there is a streaming video being viewed in the car, and the system will provide a contextual offer related to the video/entertainment content. In one embodiment, the user is tracked, and the system provides contextual offers. The offers could be physically delivered, emailed, delivered to mobile device, or otherwise delivered to a user electronically. The offers could also be delivered to a store's database/system, so upon checkout, the user will automatically get discount from the offer.

Utensil Information Gathering

In another embodiment, the system may implement monitoring technology in a user's silverware, plate, or other food preparation or eating utensils, so that the system may present contextual offers based on food selections (for example, if doing a lot of BBQ, then BBQ sauce offers; or if eating a lot of red meat, then Lipitor offer, etc). The monitoring technology may be a small camera, sensor with protein density evaluating capabilities, or other technology able to determine the type of food. Alternatively, the information gathering source may be a mobile/online application where the user enters the foods consumed. In one embodiment, the user is tracked, and the system provides contextual offers. The offers could be physically delivered, emailed, delivered to mobile device, or otherwise delivered to a user electronically. The offers could also be delivered to a store's database/system, so upon checkout at the physical store, the user will automatically get discount from the offer.

Body Measurement Device

In one embodiment, the system obtains information about a user based on a user's use of a weight measurement device or body mass index analytic device. Personalized offers may be presented to the user based on single points of data or aggregate points of data (for example, someone is losing weight, so the user is presented offers for low-top shirts; alternatively, a user is gaining weight, so the user is presented with an offer for a weight loss program). The offers could be physically delivered, emailed, delivered to mobile device, or otherwise delivered to a user electronically.

Computerized Smart Vision System

The system may be integrated with computerized smart vision systems (such as Google glasses) to present offers based on what the user is viewing, has viewed, or a combination of viewing multiple items over time or during a specified temporal period (for example, viewer looks at steaks, corn, and charcoal in the past 20 minutes, so the system presents user with an offer for BBQ sauce). In one embodiment, the user is tracked, and the system provides contextual offers. The offers could be physically delivered, emailed, delivered to mobile device, or otherwise delivered to a user electronically. The offers could also be delivered to a store's database/system, so upon checkout, the user will automatically get discount from the offer.

Transmitter Based in Phone

In one embodiment, the system can share data about a user based on geo-location or other information based on data from a phone. When the user enters a store, the system may automatically share user data, either through a system database, or via a device on the user (e.g. smartphone, ipad, dongle, and the like). The system tracks the user as well to add to the personalization information about the user that is part of the system, and that allows more personalized and contextual information to be provided.

Casino Win Bonus and Merchant Sponsored Offers

The system is not limited to browser or mobile based interfaces. In one embodiment, the system is implemented in casino type games. These may be slot machines, table games, or other casino-style games. The system may be utilized with a casino player's card system for presenting contextual offers to the user during game play. One advantage of the system is the ability to provide personalized and contextual offers to the user even when a user does not win the individual play or bet. For example, if a user bets $10 on a hand of black jack and wins, a user gets the wager plus a free medium pizza (based on user demographics and user behaviour).

The system adds to the casino revenue stream by allowing third party offers to be presented to players, either during play or at the conclusion of play, when their player card (typically obtained from the casino) is updated.

Mystery Offer

In one embodiment, the system may offer (e.g. for a select group of players who have spent a specific amount of time with a particular game/app or they've interacted with a specific vendor) a mystery offer that may include a special offer, the opportunity to level-up, or a package of goods/virtual goods. The mystery offer could be offered to just one person, or it could be an invitation for a “playoff” with other people meeting the personalized selection criteria that triggered the system to present a mystery offer. The mystery offer can be tied to any suitable trigger as noted above. This is a way for advertisers to reach users that may or may not fit their specific demographic metrics.

Real Life Games

In one embodiment, the user is playing real-life games. For example, the user is playing a game at a fair. The fair game may have a video monitor, card reading system, or other technology to identify the user. Based on the user's profile, history of performance in playing real-life games, and/or other business criteria, the fair game may present the user with a personalized offer or reward based offer. The offers could be physically delivered, emailed, delivered to mobile device, or otherwise delivered to a user electronically.

Use of Local Virtual Currency

The system is compatible with environments (such as role playing games) that have their own virtual currency. For example, Game X has virtual currency and an embodiment of the present invention incorporates Game X's virtual currency is as part of a personalized offer to the player playing Game X. This may be in combination with another offer or a standalone offer of virtual currency personalized based on the player's play, demographics, and other elements. Local virtual currency may be combined with a real world offer.

In all of the various embodiments involving personalization, the aggregate information obtained through various sources is added to the database and utilized to better personalize offers to users regardless of the offer presentation source the user chooses to use.

Offer Acceptance and Validation

Autofill—Information Store—Sweepstakes/Form Entry

The system provides the ability to enter a form/sweepstakes form in the native environment (e.g. the system environment). Even if an offer comes from outside the system, the system can provide the user the ability to accept or decline that offer without leaving the system (e.g. without going to another website). This may be accomplished by providing API's and templates to all participating advertisers. In other embodiments, the system can read metadata or XML data from a destination website, collect the data from the personalization database, and handle all the communication with the third party website behind the scenes so from the user's perspective it is a seamless/smooth user experience.

Offers

Offers to present to users will be accumulated by utilizing a variety of means including (but not limited to): Affiliate brokers, direct affiliate or contractual agreements with merchants (whether the merchants use the self-serve features or not), and sweepstakes mechanisms for cash/offers/benefits.

### Example Embodiment

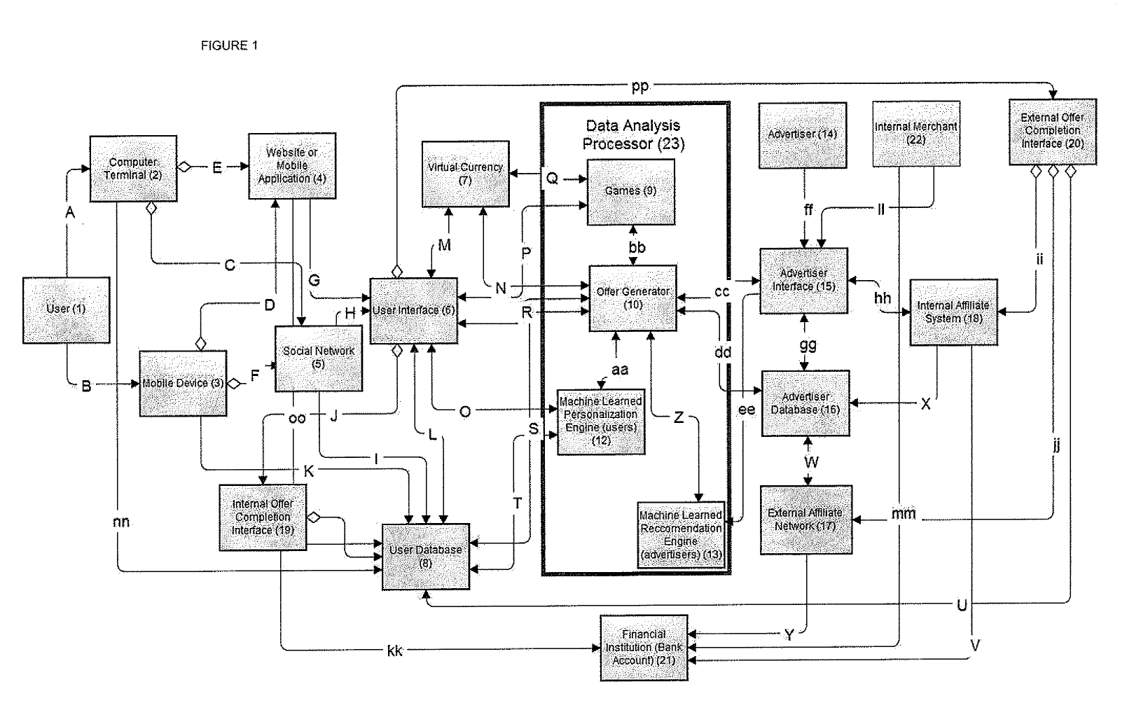

FIG. 1 is a diagram of the structure and operation of an embodiment of the system. A user 1 can interact with the system via a terminal 2 or mobile device 3. The terminal 2 may be an electronic or electromechanical hardware device that is used for entering data into, and displaying data from, a computer or a computing system. Terminal 2 includes, but it not limited to, personal computers, laptop computers, video game consoles (e.g. Xbox, PlayStation), and the like.

The Mobile device 3 is a mobile version of a computer terminal and may be embodied as a smart-phone, tablet computer, or other mobile device with internet and/or mobile application capability.

The user 1 interacts with the application via a Website or Mobile Application 4. The website may be accessed via the terminal 2 or the mobile device 3. The Website 4 in one embodiment is a collection of related web pages containing images, videos or other digital assets, accessible via a network such as the Internet or a private local area network through an Internet address known as a Uniform Resource Locator. The Mobile Application may be an application for mobile devices that allows for interaction/use similar to a website but native to a mobile device.

In other embodiments, the user can interact with the system via a Social Network 5. The Social Network 5 may be a mobile application or web based social platform like Facebook or Twitter where users interact and communicate with other users.

However the user 1 engages the system, the user 1 interacts via a User Interface 6. The user interface is the primary interface where user 1 plays games and is presented with offers. User 1 enters information into user interface 6 through the operations of playing games, entering preference or personal data (for example, surveys), and making choices with regard to offers. Information about the user 1 and other pertinent data relating to offers and other information is stored in User Database 8.

A Virtual Currency module 7 tracks the fictitious and nominally valueless online tokens may be redeemed for opportunities using the system. The virtual currency also includes an envisioned offer store, where users may redeem online currency for specific offers of their choosing.

Data Analysis Processor

The system includes in one embodiment a Data Analysis Processor 23 that includes modules for Games 9, Offer Generator 10, Personalization Engine 12 and Recommendation Engine 13. The Data Analysis Processor 23 directly accesses information from social networks or third party aggregation services through login system, user submitted information, and user interactions with offers (machine learning from user interaction with system—history of binary acceptance/denial of offers).

The Games module 9 stores information, code, and/or links to games that the user 1 may play using the system. The user may play games and win specific offers or virtual currency that may be redeemed for Offer Wheel spins (which result in an offer) or specific offers. Games may also include gamified applications. This may include a user interface for app/game developers to enter their own games for use within the system. The app/game user interface may provide templates for basic look and feel to be compatible with the app/game. The templates may allow options for the developer, such as including (but not limited to): a logo, text font, text color, text size, choosing primary and secondary foreground colors, primary and secondary background colors; age range, and gender scale (e.g. from 0-100% female).

The Offer generator 10 utilizes information from the user database, apps/games, and machine learning system engine to generate offers personalized for each user. This includes but is not limited to the offer resulting from an Offer Wheel spin. The offer generator 10 may also incorporate a weighted scale to provide users with more attractive (higher value gift certificates or more % off coupons) depending on user's completion of surveys, number of offers selected in the past, success in gaming, recommendation of friends, posting on social network sites, and/or some combination of these and other elements.

The Machine Learning Personalization Engine 12 uses data provided by the user, as well as data collected by the system based on actual activity of the user 1. This data can include games played, amount of time spent, offers selected, purchases made, points earned, advertisements click through, and the like. The Machine Learning Personalization Engine 12 uses the data to define and refine a user profile that can be used by other parts of the system to provide more personalized opportunities to the user 1.

The Machine Learning Personalization Engine (12) and the Machine Learning Recommendation 13 (used to assist in the selection of offers or ads) utilize algorithms that organize the information as described in conjunction with FIG. 13.

The Advertisers module 14 is a database of third parties that provide coupons, gift certificates, discounts, promotional items, or other forms of advertising to be awarded to users as offers. This may be merchants or proxies for the merchants (e.g. advertising agencies, publishers, and the like).

The Advertiser Interface 15 is the primary interface where advertisers (14) input and receive information from the system. For example, advertisers may choose the duration, quantity of offers, the percentage of discount, the amount of gift certificates, geographical limitations, limiting offers to users with specific demographic information, how many offers are released per hour, as well as other information. This interface allows advertisers to manage and customize ads, adjust parameters, define desired demographics for particular ads, all without needing assistance from the system administrator.

Each offer can include a plurality of metadata that can be used by the merchant to define the preferred receiver of the offer, temporal aspects of the offer (either length of time to run the offer and/or particular times and days to make the offer). A merchant may have a plurality of offers that are appropriate for a variety of users, and the Advertiser Interface 15 allows the merchants to upload multiple and different types of offers as well as to define appropriate users for the offers. Each offer can have some associated conditional rules that can help customize the offer even further. For example, if an offer is for a male in the 18-25 range, and a user fits that description, the offer could also have a conditional rule that provides greater or lesser rewards depending on if the user “won” the game or earned some other achievement associated with the system. Alternatively, the offer may have a conditional rule if the user fits a particular behavioral or demographic category.

Information about the offers, prospective customers and metadata is stored in Advertiser Database 16.

The External Affiliate Network module 17 is a network of affiliate offers; acting as an intermediary between publishers and merchant affiliate programs. The external affiliate network brokers and organizes payments made into the system in exchange for a user making a purchase, completing a survey, or completing another task. The Internal Affiliate System 18 is similar to external affiliate system 17, however, the internal affiliate system is managed internally with no fees paid to the external network.

An Internal Offer Completion Interface 19 provides a direct method to complete user financial transactions within the system, without the need to navigate to an external system site. By contrast, an External Offer Completion Interface 20 allows users to make financial transactions/purchases on a third party merchant's website (like Amazon.com).

The Financial Institution module 21 links to a bank, credit union, or other financial institution capable of processing financial transactions associated with the system.

The system may also provide an Internal Merchant module 22 that implements a store, utilizing traditional ecommerce format, to offer goods/services directly to users.

Operation of the System

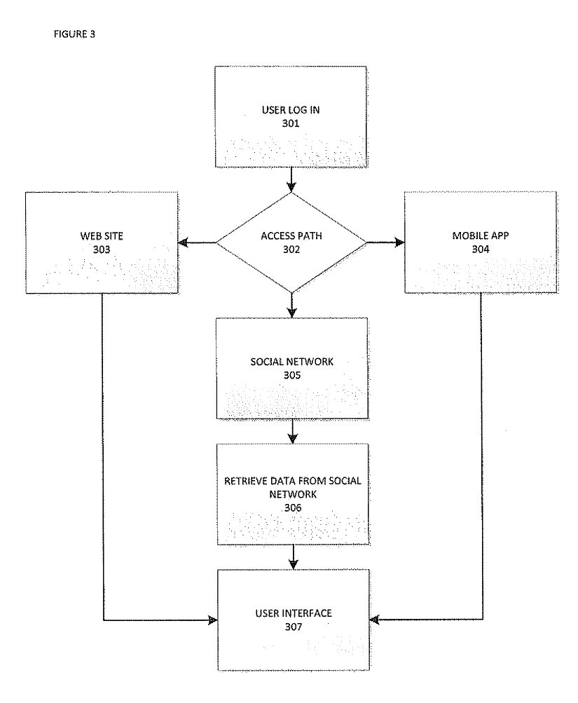

FIG. 3 is a flow diagram illustrating the operation of an embodiment of the system. At step 301 a user logs into the system using a computer terminal, video game system, or mobile device. At step 302 the system determines how the user is accessing the system. If it is a website the system proceeds to step 303. If it is a mobile app the system proceeds to step 304, and if it is a social network the system proceeds to step 305. The user interface may appear differently in a website, mobile app, or social network.

When the user accesses a social network, the user's data is retrieved from the social network and brought into the system at step 306. After steps 303, 304, or 304, the user is presented with the system user interface at step 307. At this point there are a number of options that can occur and these are described in subsequent Figures.

FIG. 4 is a flow diagram illustrating operation of the system after the user has reached the user interface. At step 401 the user accesses the user interface. At step 401 the system determines the user's device accessing the system. Personalization of offers may also be derived from determining the user's device. At decision block 402 it is determined if the user will interact with an internal offer. If so, the system takes the user to an Internal Offer Completion Interface (19) at step 403 to complete an offer within the present inventions internal ecosystem. For mobile devices, in one embodiment the offer may be emailed, sent via text message, enabling a phone call from the advertiser to the user's phone, or other method of communication (for this embodiment, offer completion is performed using a link in user's email, responding to a text message, through a phone call, or other means outside the user interface of the system).

At step 404 the system updates the user database with appropriate information from the internal offer interaction. This information includes all elements from which the user interface (6) collects information, and includes all elements from which the user database (8) has collected information.

If the user has not accessed an internal offer at 402, the system moves to decision block 405 to determine if the user has earned virtual currency. If so, the system updates the user's virtual currency account at step 406 and exchanges information with the personalization engine at step 407. After step 404 or step 407, the user proceeds to the game interface at step 408.

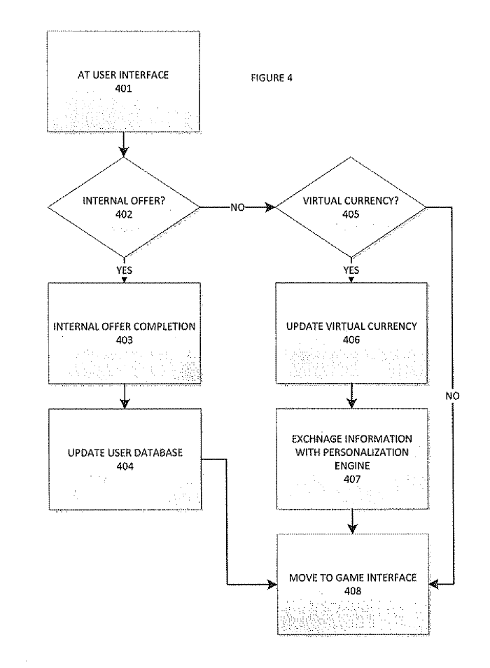

FIG. 5 is a flow diagram illustrating the system during game play in one embodiment. At step 501 the user selects an app/game to play. At step 502 the system determines if there is a pre-app/game offer associated with this app/game and/or with this user. If so, the system presents the offer at step 503. This offer will typically be customized for the user based on demographic and personalization data associated with the user. The offer may be a stand-alone offer or it may be associated and modified based on some result of the app/game. The system then proceeds to app/game play at step 504 and the user plays the app/game.

At decision block 505 it is determined if there are any achievements associated with the app/game and/or user. The achievements could be associated with current app/game play in the app/game (e.g. score achieved, level achieved, unique game play accomplishment) or it could be associated with extra-app/game situations (such as number of visits, length of time on the system, total number of this app/game played, total number of different app/games played, and the like). If so, the system awards the achievement at step 506. If not, the system continues app/game play at step 507.

At decision block 508 it is determined if the app/game is over. If not, the system returns to step 504 and play continues. If so, the system proceeds to step 509 and selects a custom offer for the user based on a number of factors. These factors can include the score/level achieved in the app/game, any achievements unlocked with the app/game, the demographic and personalization information of the user, temporal or seasonal information associated with the merchant providing the offer, the history of offers made to the user, and the like. At step 510 the offer is presented to the user. In one embodiment, offers are presented to the user during app/game play rather than at the end of play.

Offer Generator

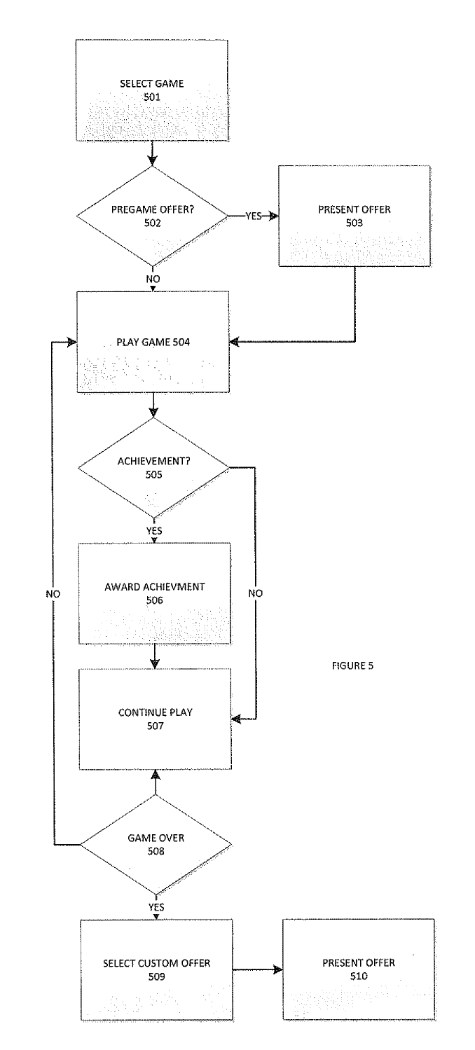

FIG. 6 is a flow diagram illustrating the operation of offer generation in one embodiment of the system. At step 601 the system generates an offer trigger. An offer trigger is an event, situation, circumstance, request, or some other condition for which the system determines if an offer is appropriate. At step 602 the system analyzes the trigger, determines the type of trigger it is and compares the trigger to a database of advertiser's triggers in the advertiser database. At step 603 the system identifies all advertisers who have indicated a desire to provide an offer when this particular trigger is generated.

At step 604 the system retrieves the personalization data for the user associated with the trigger. As noted above, the trigger could have been generated in a number of ways. It could have been generated from log-in, from app/game selection, from internal offer selection, from app/game achievement, from pre-app/game offer selection, from score achieved, from level achieved, and the like.

At step 605 the system compares the personalization data of the user to the metrics defined by each advertiser that was identified in step 603. As noted previously, an advertiser can define metrics and metadata of users to whom it wishes to advertise or make offers. At step 606 the system generates a score for how closely the personalization data of the user matches the metrics of the advertiser.

At step 607 the system identifies the top scoring advertiser. This advertiser will have the opportunity to serve an ad or offer based on the trigger to the user. In one embodiment, the selected advertiser may be an advertiser with the top score or it may be an advertiser who has paid a certain price to guarantee ad serve for this particular trigger based on time of day, day of week, geographical location, gender of user, type of app/game, or other metrics that can be defined by the system.

At step 608, the system compares all ads and offers of that advertiser to the personalization data of the user and ranks the available offers in order of effectiveness for that user. This means that the system determines the ad or offer that is most likely to result in an affirmative or successful response from the user. At step 609 the system serves the top ranked ad to the user.

Dynamic Sorting of Offers Based on Real-Time Data

The system uses a bucket sync system to review advertiser campaigns, determine which campaigns/offers were viewed, then apply a frequency monitor to prevent the same offers from being seen before the other offers are displayed first (to avoid seeing the same offer twice in a row, or in very close temporal proximity). For the next user session, then the sync goes to the offer that is most clicked or another ranking based on “business criteria.”

When an offer is targeted, the targeting mechanism will choose from this bucket. It will consider the top offers first and then demographic information, etc. In one embodiment the system uses rating as the primary metric—however, the system may also apply historical data to provide another embodiment for selecting an offer. In this embodiment, a think mechanism reviews each offer in a bucket, or each potential offer, and reviews the history. The think mechanism knows if an offer was viewed X amount of times, or if was clicked X amount of times and it was redeemed X amount of times. For example, the system can place the offers with the highest redemption rates at the top, or the highest click-through rates at the top, depending on the business criteria to be implemented. For the other offers, the values may be lowered.

For the Bucket sync, in one embodiment it reviews all system campaigns. Some campaigns may be an A/B campaign, where there are two offers or two types of offers (offer “A” and offer “B”). The system determines which offer has the most and which has the least number of views. In determining which offer to present, the system can use this numerical and historical data to distribute views between the “A” and “B” offers evenly, or pursuant to an advertiser request. In other cases, the system reviews the user and attempts to avoid consecutive presentations of the “A” offer, for example, and seeks to alternate offers so the user does not see the same offer more than once.

On subsequent bucket syncs, the system will see how many views offer “B” had and if offer “B” has less views than offer “A,” the system may put offer “B” in the bucket. Another example is if offer “B” had less views, but a higher click-through rate, then offer “B” may be placed higher in the bucket. The specific logic changes based on business criteria. The system is able to evaluate all the historic data in real time. The time window of analysis can also be changed so that the system can review history by day, week, month, and the like.

The bucket may also incorporate specific user preferences in its sync. For example, in an A/B test, a specific user may see only offer “A” and not offer “B” (in the same advertiser campaign). Over the course of time, the system recognizes the types of offers that the specific player has selected (or rejected) in the past, and thus will load a corresponding offer from the A/B test that correlates to an offer the specific player is most likely to accept/redeem.

Even binary responses (accepting or declining offers) provide the system with relevant information from which to personalize subsequent offers for that user and for other users with similar demographics/behavior history. Click history, redemption history, and other behavioral elements also go into the database.

The Offer Generator exchanges information with the Machine Learning Recommendation Engine. The Machine Learning Recommendation Engine helps advertisers choose effective offers; therefore, the Offer Generator provides information about users specific to offers such as offers accepted or declined, the context of the acceptance or decline (e.g. game played, time of day, day of week, value/cost of offer, relationship to prior offers from the same advertiser, and other data metrics and metadata that can aid in fine tuning offers for a particular user.

The Offer Generator (10) also exchanges information with the Machine Learning Personalization Engine 12 for the purpose of enhancing offer personalization for the Offer Generator (10). This also collects information from the Offer Generator (10) (based on user choices) to create better personalization in the Machine Learning Personalization Engine (12)

The Advertiser Interface (15) also exchanges information with the Machine Learning Recommendation Engine (13), which allows improved advertiser (14) recommendations regarding what offers create results with users (1). This may include, but is not limited to, the Machine Learning Recommendation Engine (13) providing advertisers (14) with data on what users (1) accepted offers, what users (1) declined offers, and recommendations for the types of offers that are likely to generate results for the advertiser (14). As noted above, this information can also include contextual information such as time of day, length of time or number of times playing a game, value/cost of the offer, and the like. For example, if an offer is available to a user and the offer includes conditions for maximizing the value or lowering the cost, it may be that a particular user only responds to offers after the value has been maximized or the cost lowered. In such a case, it may be useful to provide an easier path for the user to obtain the maximum value in order to entice that user to accept an offer.

User Experience

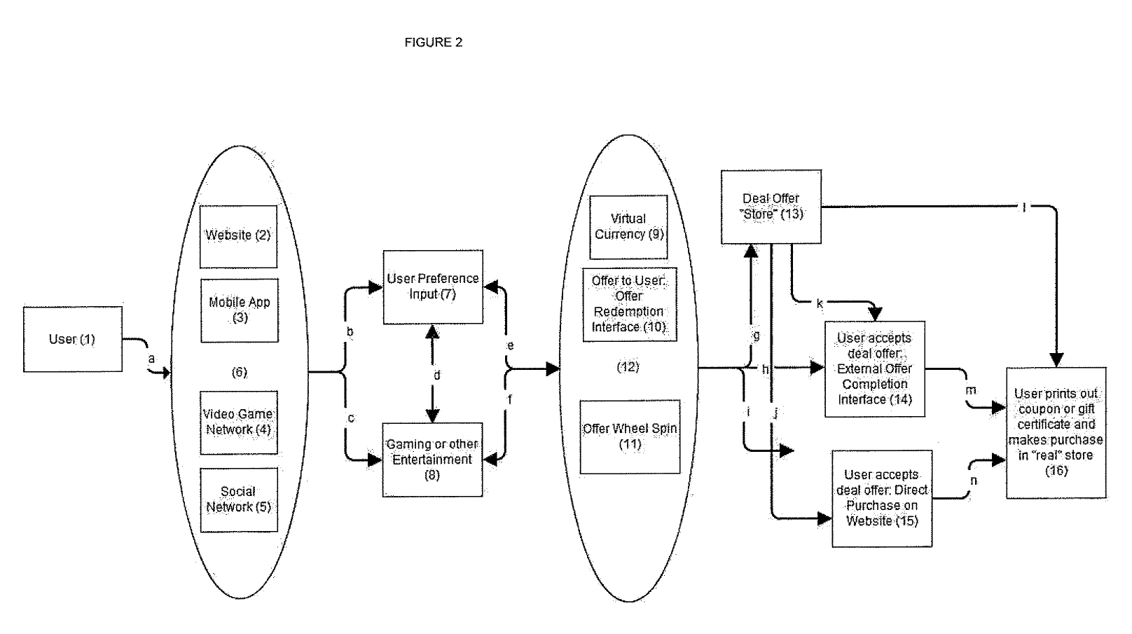

FIG. 2 illustrates the system experience from the perspective of user 1. The User (1) accesses the system via a website (2), mobile app (3), video game network (4), social network (5), or other application of invention. User 1 optionally logs in through log-in system. It should be noted that play/entertainment may also be available without login.

User 1 has an opportunity to provide personal information and preferences via User Preference Input 7. To encourage the user to participate, the system may receive an offer or virtual currency immediately after user completes this information disclosure. User 1 may also receive virtual currency (9), and/or may continue gaming/entertainment (8), Surveys may appear before, during, or after app/game play. Timers may be attached to the User 1's information disclosure step, so that even if User 1's information disclosure is not completed, User 1 is able to return to app/game play after the timer expired (when a timer is used, User 1 may return to app/game play immediately after completing the information disclosure—even if the timer has not yet expired).

User 1 selects an app/game or item for entertainment (8). User 1 plays the app/game or views/hears the entertainment. User 1 has multiple of choices of apps/games.

During User 1's interaction with the system, User 1 is presented with an offer (offer to user: offer redemption interface) (10). In one embodiment, the offer is a binary yes/no offer. User 1 may also be presented with virtual currency (9). User 1 has the opportunity to redeem winnings of virtual currency right away or “Bank” winnings of virtual currency for use at a later time.

In one embodiment, the virtual currency may be used for “Offer Wheel Spins” (11) or for offer for goods/services/cash (10). Each “Offer Wheel Spin” results in the user being presented with an offer. This mini-system of the virtual currency (9), offer redemption interface (10), and Offer Wheel spin (11) are collectively labeled (12). User 1 may redeem virtual currency in the offer store for specific offers (13).

If User 1 selects an offer, User 1 is directed to the external offer completion interface (14) or the internal offer completion interface (15). The external offer completion interface (14) directs User 1 to a third party merchant's system to complete the financial transaction necessary to make purchases. The internal offer completion interface (15) gives the user the opportunity to, in the system, complete the financial transaction necessary to make purchases.

Alternatively, the system may deliver offers to a player's mobile phone via SMS or some other mechanism. The offer can be a scannable image (e.g. bar code, 2D bar code, VR code, and the like) that allows redemption, or it could be cash for using the phone as a virtual wallet. The system may also deliver offers directly to the user's game system (Xbox and the like) or provide a simple accept/decline interface for things such as free pizza to be delivered based on an in-app/game offer.

User 1 may utilize selected offers in virtual or real stores. User 1 may print out coupon or gift certificate for use in a “real” store (19) (e.g. one with a physical space for consumers; like a store in a mall).

Example Computer Environment

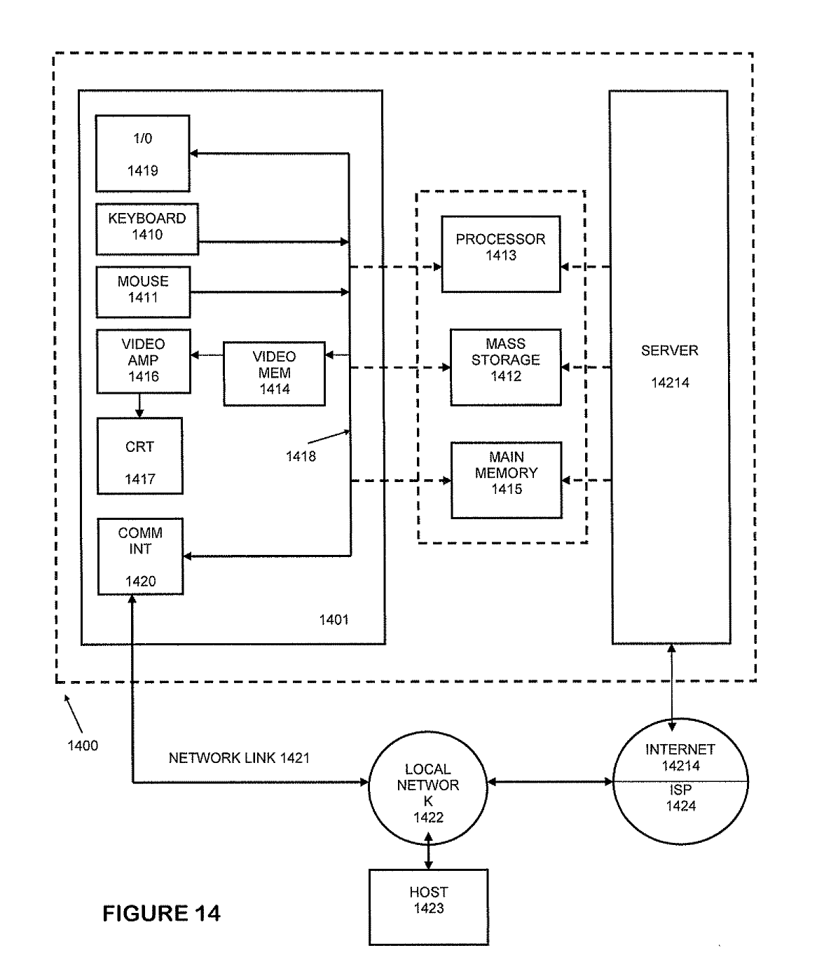

An embodiment of the system can be implemented as computer software in the form of computer readable program code executed in a general purpose computing environment such as environment 1400 illustrated in FIG. 14, or in the form of bytecode class files executable within a Java™ run time environment running in such an environment, or in the form of bytecodes running on a processor (or devices enabled to process bytecodes) existing in a distributed environment (e.g., one or more processors on a network). FIG. 14 may be scaled, so that there are multiple/stacked/clustered processors and/or servers that are networked together to perform a set of functions. A keyboard 1410 and mouse 1411 are coupled to a system bus 1418. The keyboard and mouse are for introducing user input to the computer system and communicating that user input to central processing unit (CPU 1413). Other suitable input devices may be used in addition to, or in place of, the mouse 1411 and keyboard 1410. I/O (input/output) unit 1419 coupled to bi-directional system bus 1418 represents such I/O elements as a printer, A/V (audio/video) I/O, etc.

Computer 1401 may be a laptop, desktop, tablet, smart-phone, or other processing device and may include a communication interface 1420 coupled to bus 1418. Communication interface 1420 provides a two-way data communication coupling via a network link 1421 to a local network 1422. For example, if communication interface 1420 is an integrated services digital network (ISDN) card or a modem, communication interface 1420 provides a data communication connection to the corresponding type of telephone line, which comprises part of network link 1421. If communication interface 1420 is a local area network (LAN) card, communication interface 1420 provides a data communication connection via network link 1421 to a compatible LAN. Wireless links are also possible. In any such implementation, communication interface 1420 sends and receives electrical, electromagnetic or optical signals which carry digital data streams representing various types of information.

Network link 1421 typically provides data communication through one or more networks to other data devices. For example, network link 1421 may provide a connection through local network 1422 to local server computer 1423 or to data equipment operated by ISP 1424. ISP 1424 in turn provides data communication services through the world wide packet data communication network now commonly referred to as the “Internet” 14214 Local network 1422 and Internet 14214 both use electrical, electromagnetic or optical signals which carry digital data streams. The signals through the various networks and the signals on network link 1421 and through communication interface 1420, which carry the digital data to and from computer 1400, are exemplary forms of carrier waves transporting the information.

Processor 1413 may reside wholly on client computer 1401 or wholly on server 14214 or processor 1413 may have its computational power distributed between computer 1401 and server 14214. Server 14214 symbolically is represented in FIG. 14 as one unit, but server 14214 can also be distributed between multiple “tiers”. In one embodiment, server 14214 comprises a middle and back tier where application logic executes in the middle tier and persistent data is obtained in the back tier. In the case where processor 1413 resides wholly on server 14214, the results of the computations performed by processor 1413 are transmitted to computer 1401 via Internet 14214, Internet Service Provider (ISP) 1424, local network 1422 and communication interface 1420. In this way, computer 1401 is able to display the results of the computation to a user in the form of output.

Computer 1401 includes a video memory 1414, main memory 1415 and mass storage 1412, all coupled to bi-directional system bus 1418 along with keyboard 1410, mouse 1411 and processor 1413.

As with processor 1413, in various computing environments, main memory 1415 and mass storage 1412, can reside wholly on server 14214 or computer 1401, or they may be distributed between the two. Examples of systems where processor 1413, main memory 1415, and mass storage 1412 are distributed between computer 1401 and server 14214 include thin-client computing architectures and other personal digital assistants, Internet ready cellular phones and other Internet computing devices, and in platform independent computing environments,

The mass storage 1412 may include both fixed and removable media, such as magnetic, optical or magnetic optical storage systems or any other available mass storage technology. The mass storage may be implemented as a RAID array or any other suitable storage means. Bus 1418 may contain, for example, thirty-two address lines for addressing video memory 1414 or main memory 1415. The system bus 1418 also includes, for example, a 32-bit data bus for transferring data between and among the components, such as processor 1413, main memory 1415, video memory 1414 and mass storage 1412. Alternatively, multiplex data/address lines may be used instead of separate data and address lines.

In one embodiment of the invention, the processor 1413 is a microprocessor such as manufactured by Intel, AMD, Sun, Arm Holdings, etc. However, any other suitable microprocessor or microcomputer may be utilized, including a cloud computing solution. Main memory 1415 is comprised of dynamic random access memory (DRAM). Video memory 1414 is a dual-ported video random access memory. One port of the video memory 1414 is coupled to video amplifier 1419. The video amplifier 1419 is used to drive the cathode ray tube (CRT) raster monitor 1417. Video amplifier 1419 is well known in the art and may be implemented by any suitable apparatus. This circuitry converts pixel data stored in video memory 1414 to a raster signal suitable for use by monitor 1417. Monitor 1417 is a type of monitor suitable for displaying graphic images.

Computer 1401 can send messages and receive data, including program code, through the network(s), network link 1421, and communication interface 1420. In the Internet example, remote server computer 14214 might transmit a requested code for an application program through Internet 14214, ISP 1424, local network 1422 and communication interface 1420. The received code maybe executed by processor 1413 as it is received, and/or stored in mass storage 1412, or other non-volatile storage for later execution. The storage may be local or cloud storage. In this manner, computer 1400 may obtain application code in the form of a carrier wave. Alternatively, remote server computer 14214 may execute applications using processor 1413, and utilize mass storage 1412, and/or video memory 1415. The results of the execution at server 14214 are then transmitted through Internet 14214, ISP 1424, local network 1422 and communication interface 1420. In this example, computer 1401 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, flash memory devices, and carrier waves.

The computer systems described above are for purposes of example only. In other embodiments, the system may be implemented on any suitable computing environment including personal computing devices, smart-phones, pad computers, and the like. An embodiment of the invention may be implemented in any type of computer system or programming or processing environment.

While the present invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A method of delivering an offer to a user comprising:
Using a processing system,
Providing an entertainment to the user;
Retrieving a personalization profile of the user;
Using the personalization profile to identify at least one offer that is optimized for the personalization profile;
Presenting the offer to the user in connection with the entertainment.

2. The method of claim 1 wherein the entertainment is a computer game.

3. The method of claim 1 wherein the entertainment is an application.

4. The method of claim 1 wherein the entertainment is digital media content.

5. The method of claim 1 wherein the entertainment is provided via a browser.

6. The method of claim 1 wherein the entertainment is provided via an application.

7. The method of claim 1 wherein the entertainment is provided via a game console.

8. The method of claim 1 wherein the offer is an advertisement.

9. The method of claim 1 wherein the offer is a deal.

10. The method of claim 1 wherein the offer is a promotional item.

11. The method of claim 1 wherein the entertainment is in the physical world.

12. The method of claim 11 wherein the entertainment is a casino style game.

13. The method of claim 1 wherein the personalization profile includes geo-location information.

14. The method of claim 1 wherein the personalization profile includes information provided by the user

15. The method of claim 1 wherein the personalization profile includes social media data of the user.

16. The method of claim 1 wherein the personalization profile includes historical data of the user interacting with the processing system.

17. The method of claim 16 wherein the historical data includes risk preferences of the user.

18. The method of claim 16 wherein the historical data includes the user's propensity to share offers with others.

19. The method of claim 1 wherein the personalization profile includes data from a device used by the user.

20. The method of claim 19 wherein the device comprises computerized smart glasses.

21. The method of claim 19 wherein the device comprises a computerized smart vehicle

22. The method of claim 19 wherein the device comprises smart utensils.

23. The method of claim 19 wherein the device comprises a mobile device.

24. The method of claim 1 wherein the offer is presented in response to an event in the entertainment.

25. The method of claim 24 wherein the event is an achievement.

26. The method of claim 1 wherein parameters of the offer are conditional on user interaction with the entertainment.

27. The method of claim 1 further including inserting product placement in the entertainment.

28. The method of claim 27 wherein the product placement to be inserted is based on the personalization profile of the user.

29. The method of claim 1 wherein presenting the offer is conditional on an automated verification of offer validity.

30. A method of generating an offer comprising:
In a processing system;
Receiving demographic target data from an advertiser;
Comparing the demographic target data with historical data associated with the demographic target data;
Identifying the most successful offers from the historical data associated with the demographic target data;
Presenting the most successful offers to the advertiser.

31. The method of claim 30 wherein the historical data includes the type of offer presented.

32. The method of claim 30 wherein the demographic target data includes at least one of gender, geographic location, age range, and risk preference.

33. The method of claim 30 further including generating a plurality of offers that are presented to the user pursuant to a dynamic sorting process.

34. The method of claim 33 wherein the dynamic sorting process is such that the same offer is not presented within the same session to the same user.

35. The method of claim 30 wherein the historical data includes positive correlation between categories and offers accepted by the user.
